(19) United States
(12) Patent Application Publication
(10) Pub. No.: US 2026/0277751 A1
(43) Pub. Date: Sep. 17, 2026

(54) CLOUD SYSTEM

(71) Applicant: KYOCERA Document Solutions Inc., Osaka-shi (JP)

(72) Inventors: Koki NAKAJIMA, Osaka-shi (JP); Yuki YOKOZAWA, Osaka-shi (JP)

(21) Appl. No.: 18/878,190

(22) PCT Filed: Jun. 26, 2023
(86) PCT No.: PCT/JP2023/023542

§ 371 Date: Dec. 23, 2024

(30) Foreign Application Priority Data
Jun. 28, 2022 (JP) 2022-103674
Jun. 28, 2022 (JP) 2022-103675
Jun. 28, 2022 (JP) 2022-103676

(51) Int. Cl. G06F 11/1446

(52) U.S. Cl. CPC G06F 11/1464

(57) ABSTRACT

A tenant management system includes an image processing system that executes save processing which is a process of saving image data or text data received from outside in a storage service or a database service, by Web servers different for respective save processing; and a cloud controller that executes scale-out processing, scale-in processing or time-out processing, which is a process of performing scale-out, scale-in or time-out of the image processing system as necessary. The cloud controller executes the scale-out processing before execution of the save processing by the image processing system for respective save processing, executes the scale-in processing periodically, or executes the time-out processing which is a process of stopping a Web server when an elapsed time since a start time of the save processing being executed by the Web server is not shorter than a time-out period set as a time for the time-out of the save processing.

### TECHNICAL FIELD

The present invention relates to a cloud system constructed on a cloud.

### BACKGROUND ART

Conventionally, as a cloud system constructed on a cloud, a tenant management system configured by a multi-tenant model in which environment or data for respective customers are divided according to identification information of tenants, has been known (see, e.g., PTL 1).

### CITATION LIST

### Patent Literature

PTL 1: Japanese Unexamined Patent Publication No. 2019-139591

### SUMMARY OF THE INVENTION

### Problems to be Solved by the Invention

However, the conventional cloud system involves such a problem that scale-out or scale-in may not be effectively performed. In addition, there is a problem that, even if processing is backlogged for a long time in a server realizing the cloud system, the server may be continuously used as it is.

The present invention provides a cloud system capable of effectively performing scale-out or scale-in, or a cloud system capable of efficiently using a server that realizes the cloud system.

### Means for Solving the Problem

A cloud system according to one aspect of the present invention includes a data saving system that executes save processing which is a process of saving data received from outside in a specific location; and a cloud controller that executes scale-out processing or scale-in processing, which is a process of performing scale-out or scale-in of the data saving system as necessary, wherein the cloud controller executes the scale-out processing before execution of the save processing by the data saving system for respective save processing or executes the scale-in processing periodically. A cloud system according to another aspect of the present invention includes a data saving system that executes save processing which is a process of saving data received from outside in a specific location, by servers different for respective save processing; and a cloud controller that executes time-out processing which is a process of stopping a server or recovering from an error of a server when an elapsed time since a start time of the save processing being executed by the server is not shorter than a time-out period set as a time for time-out of the save processing.

Due to the above configuration, the cloud system according to the present invention executes the scale-out processing before execution of the save processing by the data saving system for respective save processing, so that it is possible to reduce the possibility of performing too much or too little the scale-out of the data saving system. In addition, the cloud system according to the present invention executes the scale-in processing of the data saving system periodically, so that it is possible to perform the scale-in of the data saving system at an appropriate timing. Therefore, the cloud system of the present invention is capable of effectively performing the scale-out or scale-in. Further, the cloud system according to the present invention stops the server or recovers from the error of the server when the elapsed time since the start time of the save processing being executed by the server is not shorter than the time-out period, so that when the processing is backlogged for a long time in the server that realizes the cloud system, it is possible to reduce the possibility of continuously using the said server as it is. Therefore, the cloud system of the present invention is capable of efficiently using the server that realizes the data saving system.

In the cloud system according to the present invention, the scale-out processing or scale-in processing may be a process in which the cloud controller does not perform the scale-out or scale-in when a number of the save processing being executed is more than a reference number of processing set as a reference for performing the scale-out or scale-in.

Due to the above configuration, the cloud system according to the present invention does not perform the scale-out of the data saving system when the number of the save processing being executed is more than the reference number of processing, so that it is possible to prevent the scale-out of the data saving system from being performed endlessly. In addition, the cloud system according to the present invention does not perform the scale-in of the data saving system when the number of the save processing being executed is more than the reference number of processing, so that it is possible to reduce the possibility of performing the scale-in of the data saving system in spite of the large number of the save processing being executed, and thus of hindering the execution of the save processing. Therefore, the cloud system of the present invention is capable of effectively performing the scale-out or scale-in.

In the cloud system according to the present invention, the scale-out processing may be a process in which the cloud controller does not perform the scale-out when a number of the save processing waiting for execution is less than a scale-out number set as a number of the scale-out for one time.

Due to the above configuration, the cloud system according to the present invention does not perform the scale-out of the data saving system when the number of the save processing waiting for execution is less than the scale-out number, so that it is possible to prevent the scale-out of the data saving system from being performed in spite of a light load that is predicted by a future execution of the save processing by the data saving system. Therefore, the cloud system of the present invention is capable of effectively performing the scale-out.

In the cloud system according to the present invention, the scale-out processing may be a process in which the cloud controller performs the scale-out by the scale-out number when the number of the save processing being executed is not more than the reference number of processing and the number of the save processing waiting for execution is not less than the scale-out number.

Due to the above configuration, the cloud system according to the present invention performs the scale-out of the data saving system by the scale-out number when the number of the save processing being executed is not more than the reference number of processing and the number of the save processing waiting for execution is not less than the scale-out number, so that it is possible to scale out the data saving system by necessary amount of the scale-out of the data saving system when the scale-out of the data saving system is required. Therefore, the cloud system of the present invention is capable of effectively performing the scale-out.

In the cloud system according to the present invention, the scale-out processing may be a process in which the cloud controller does not perform the scale-out when a number of the save processing waiting for execution is less than a scale-out number set as a number of the scale-out for one time.

Due to the above configuration, the cloud system according to the present invention does not perform the scale-out of the data saving system when the number of the save processing waiting for execution is less than the scale-out number, so that it is possible to prevent the scale-out of the data saving system from being performed in spite of a light load that is predicted by a future execution of the save processing by the data saving system. Therefore, the cloud system of the present invention is capable of effectively performing the scale-out.

In the cloud system according to the present invention, the scale-out processing may be a process in which the cloud controller performs the scale-out by a scale-out number when a number of the save processing being executed is not more than a reference number of processing set as a reference for performing the scale-out and a number of the save processing waiting for execution is not less than the scale-out number set as a number of the scale-out for one time.

Due to the above configuration, the cloud system according to the present invention performs the scale-out of the data saving system by the scale-out number when the number of the save processing being executed is not more than the reference number of processing and the number of the save processing waiting for execution is not less than the scale-out number, so that it is possible to scale out the data saving system by necessary amount of the scale-out of the data saving system when the scale-out of the data saving system is required. Therefore, the cloud system of the present invention is capable of effectively performing the scale-out.

In the cloud system according to the present invention, the scale-in processing may be a process in which the cloud controller does not perform the scale-in when the save processing waiting for execution exists.

Due to the above configuration, the cloud system according to the present invention does not perform the scale-in of the data saving system when the save processing waiting for execution exists, so that it is possible to reduce the possibility of performing the scale-in of the data saving system in spite of existence of the save processing waiting for execution, and thus of hindering the future execution of the save processing. Therefore, the cloud system of the present invention is capable of effectively performing the scale-in.

In the cloud system according to the present invention, the scale-in processing may be a process in which the cloud controller does not perform the scale-in when an elapsed time since a finish time of the save processing of which execution is finished last is shorter than a scale-in reference time set as a reference time of performing of the scale-in.

Due to the above configuration, the cloud system according to the present invention does not perform the scale-in of the data saving system when the elapsed time since the finish time of the save processing of which execution is finished last is shorter than the scale-in reference time, so that it is possible to reduce the possibility of performing the scale-in of the data saving system immediately after finishing the save processing, and thus of hindering the future execution of the save processing. Therefore, the cloud system of the present invention is capable of effectively performing the scale-in.

In the cloud system according to the present invention, the scale-in processing may be a process in which the cloud controller performs the scale-in by a scale-in number set as a number of the scale-in for one time when the number of the save processing being executed is not more than the reference number of processing, the save processing waiting for execution does not exist, and the elapsed time since the finish time of the save processing of which execution is finished last is not shorter than the scale-in reference time.

Due to the above configuration, the cloud system according to the present invention performs the scale-in of the data saving system by the scale-in number when the number of the save processing being executed is not more than the reference number of processing and the save processing waiting for execution does not exist as well as the elapsed time since the finish time of the save processing of which execution is finished last is not shorter than the scale-in reference time, so that it is possible to scale in the data saving system by necessary amount of the scale-in of the data saving system when the scale-in of the data saving system is required. Therefore, the cloud system of the present invention is capable of effectively performing the scale-in.

In the cloud system according to the present invention, the scale-in processing may be a process in which the cloud controller does not perform the scale-in when the save processing waiting for execution exists.

Due to the above configuration, the cloud system according to the present invention does not perform the scale-in of the data saving system when the save processing waiting for execution exists, so that it is possible to reduce the possibility of performing the scale-in of the data saving system in spite of existence of the save processing waiting for execution, and thus of hindering the future execution of the save processing. Therefore, the cloud system of the present invention is capable of effectively performing the scale-in.

In the cloud system according to the present invention, the scale-in processing may be a process in which the cloud controller does not perform the scale-in when an elapsed time since a finish time of the save processing of which execution is finished last is shorter than a scale-in reference time set as a reference time of performing of the scale-in.

Due to the above configuration, the cloud system according to the present invention does not perform the scale-in of the data saving system when the elapsed time since the finish time of the save processing of which execution is finished last is shorter than the scale-in reference time, so that it is possible to reduce the possibility of performing the scale-in of the data saving system immediately after finishing the save processing, and thus of hindering the future execution of the save processing. Therefore, the cloud system of the present invention is capable of effectively performing the scale-in.

In the cloud system according to the present invention, the scale-in processing may be a process in which the cloud controller performs the scale-in by a scale-in number set as a number of the scale-in for one time when a number of the save processing being executed is not more than a reference number of processing set as a reference for performing the scale-in, the save processing waiting for execution does not exist, and an elapsed time since a finish time of the save processing of which execution is finished last is not shorter than a scale-in reference time set as a reference time of performing of the scale-in.

Due to the above configuration, the cloud system according to the present invention performs the scale-in of the data saving system by the scale-in number when the number of the save processing being executed is not more than the reference number of processing and the save processing waiting for execution does not exist as well as the elapsed time since the finish time of the save processing of which execution is finished last is not shorter than the scale-in reference time, so that it is possible to scale in the data saving system by necessary amount of the scale-in of the data saving system when the scale-in of the data saving system is required. Therefore, the cloud system of the present invention is capable of effectively performing the scale-in.

In the cloud system according to the present invention, the cloud controller may execute the time-out processing periodically.

Due to the above configuration, the cloud system according to the present invention executes the time-out processing of the data saving system periodically, so that it is possible to execute the time-out processing of the data saving system at an appropriate timing. Therefore, the cloud system of the present invention is capable of efficiently using the server that realizes the data saving system.

### Effect of the Invention

The cloud system according to the present invention is capable of effectively performing the scale-out or scale-in. Furthermore, it is possible to efficiently use a server that realizes the cloud system.

### BRIEF DESCRIPTION OF THE DRAWINGS

FIG. 1 is an explanatory diagram of tenants managed by a tenant management system included in a system according to an embodiment of the present invention.

FIG. 2 is a block diagram of a software configuration of a system according to an embodiment of the present invention.

FIG. 3 is a block diagram of a hardware configuration of the system depicted in FIG. 2.

FIG. 4 is a diagram depicting an example of a tenant management table depicted in FIG. 2.

FIG. 5 is a diagram depicting an example of a save processing management table depicted in FIG. 2.

FIG. 6 is a diagram depicting an example of a setting table depicted in FIG. 2.

FIG. 7 is a sequence diagram depicting an operation of the system depicted in FIG. 2, when a session is established between an application for user terminal and an application by tenant.

FIG. 8 is a sequence diagram depicting an operation of the system depicted in FIG. 2, when at least one datum of image data and document data is transmitted from an application for user terminal to an image processing system.

FIG. 9 is a flowchart of an operation of a cloud controller depicted in FIG. 2, when scale-out processing is executed.

FIG. 10 is a flowchart of an operation of a cloud controller depicted in FIG. 2, when scale-in processing is executed.

FIG. 11 is a flowchart of an operation of a cloud controller depicted in FIG. 2, when time-out processing is executed.

### MODE FOR CARRYING OUT THE INVENTION

Embodiments of the present invention will be described below with reference to the drawings.

First, a configuration of a system according to an embodiment of the present invention will be described.

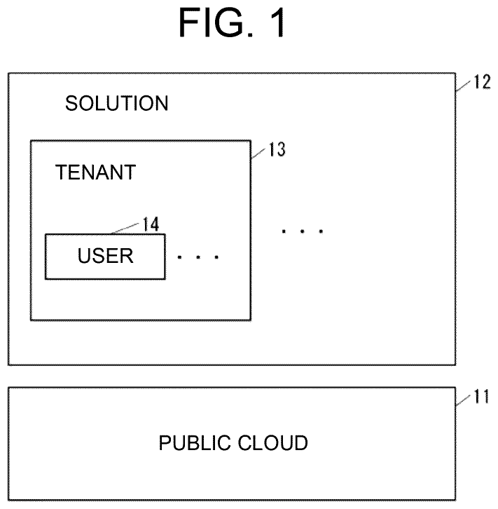

FIG. 1 is an explanatory diagram of tenants managed by a tenant management system included in a system according to the present embodiment.

As depicted in FIG. 1, a solution 12 is constructed on a public cloud 11. In this connection, for example, a document management solution for managing documents can be adopted as the solution 12.

The provider of the solution 12 may lend at least a part of the solution 12 to others. A unit in which the provider of the solution 12 lends at least a part of the solution 12 is referred to as a tenant. A plurality of tenants, such as a tenant 13, can exist in the solution 12.

A plurality of users, such as a user 14, can exist in the tenant 13. The configurations of tenants other than the tenant 13 are the same as the configuration of the tenant 13.

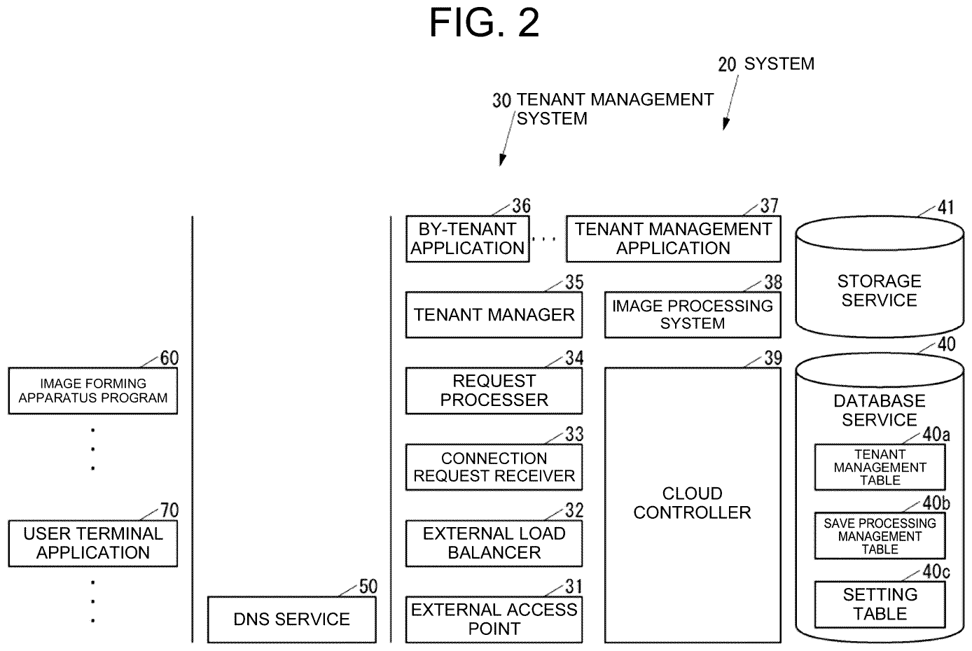

FIG. 2 is a block diagram of a software configuration of the system 20 according to the present embodiment.

As depicted in FIG. 2, the system 20 includes a tenant management system 30 as a cloud system; a Domain Name System (DNS) service 50 as a service for registering a Fully Qualified Domain Name (FQDN) of an external access point 31 described later; programs for image forming apparatus, such as an image forming apparatus program 60, as programs executed by an image forming apparatus described later; and applications for user terminal, such as a user terminal application 70, as applications executed by a user terminal described later.

The image forming apparatus program is a program for transmitting at least one datum of image data and document data to an image processing system 38 described later of the tenant management system 30, and for executing printing based on at least one datum of image data and document data received from the image processing system 38.

The user terminal application is an application for transmitting at least one datum of image data and document data to an image processing system 38 described later of the tenant management system 30, receives at least one datum of image data and document data from the image processing system 38, and executes a request for a print instruction to the image forming apparatus. The user terminal application may be an application operating on a Web browser.

The tenant management system 30 is a multi-tenant model in which environment or data for respective customers are divided according to identification information of tenants. The tenant management system 30 includes, in the public cloud 11 (see FIG. 1), an external access point 31 that is an accessible endpoint published outside the public cloud, such as outside a data center; an external load balancer 32 that is a service for retaining a connection of Hypertext Transfer Protocol (HTTP)/Hypertext Transfer Protocol Secure (HTTPS), etc., from outside and achieving a load balancing function for Web servers described later; a connection request receiver 33 that is a service for receiving a connection request from the external load balancer 32; a request processor 34 that is a service for processing requests from outside including authentication; a tenant manager 35 that is a service for making by-tenant applications described later receive requests from a user; by-tenant applications, such as a by-tenant application 36, that are applications prepared for respective tenants; a tenant management application 37 that is an application for managing various information of tenants; an image processing system 38 as a data saving system that is a service for executing a process of saving (hereinafter referred to as “save processing”) at least one datum of image data and document data received from the user terminal applications or the like, after being subjected to a specific conversion process such as converted into another format datum as needed, in a specific location, i.e., a storage service 41 (and also a database service 40 as needed) described later, and/or for reading at least one datum of image data and document data from the storage service 41 (and also the database service 40 as needed) in response to requests from the by-tenant applications; a cloud controller 39 that is a service for performing scale-out and scale-in of the image processing system 38; a database service 40 for storing a data table; and a storage service 41 for storing at least one datum of image data and document data output by the image processing system 38.

A plurality of by-tenant applications can be prepared for a single tenant. As the by-tenant applications, for example, various applications such as a document management application, a schedule book application, a chat tool, etc., can be adopted.

The database service 40 stores a tenant management table 40a for managing tenants, a save processing management table 40b for managing save processing, and a setting table 40c indicating control settings of a Web server that realizes the image processing system 38.

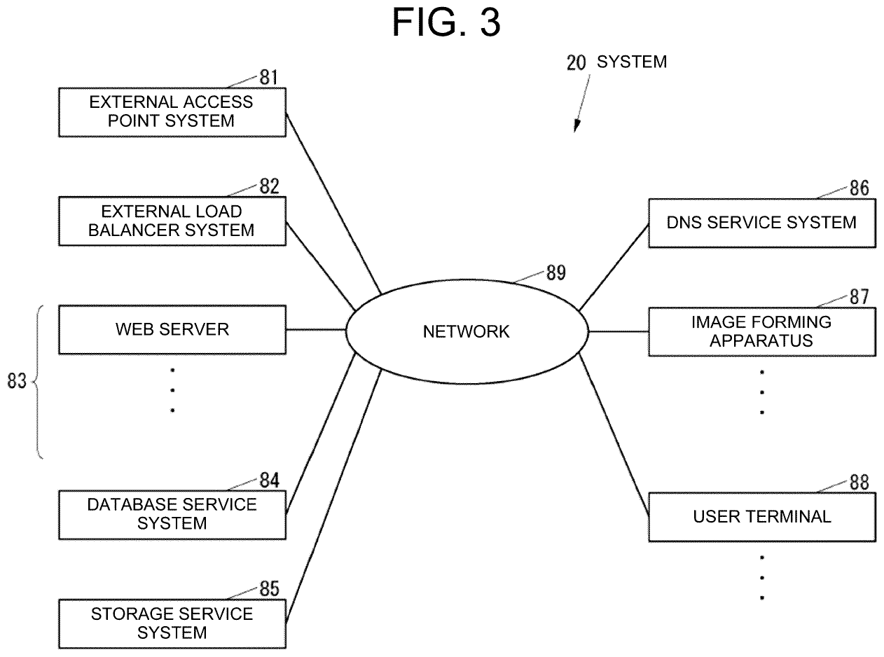

FIG. 3 is a block diagram of a hardware configuration of the system 20.

As depicted in FIG. 3, the system 20 includes an external access point system 81 for realizing the external access point 31; an external load balancer system 82 for realizing the external load balancer 32; a group 83 of Web servers; a database service system 84 for realizing the database service 40; a storage service system 85 for realizing the storage service 41; a DNS service system 86 for realizing the DNS service 50; image forming apparatuses for executing the image forming apparatus programs, such as an image forming apparatus 87 for executing the image forming apparatus program 60; and user terminals for executing the user terminal applications, such as a user terminal 88 for executing the user terminal application 70. The external access point system 81, the external load balancer system 82, the Web servers, the database service system 84, the storage service system 85, the DNS service system 86, the image forming apparatuses, and the user terminals can communicate with each other via a network 89 such as the Internet.

Each of the external access point system 81, the external load balancer system 82, the database service system 84, the storage service system 85, and the DNS service system 86 is realized by at least one computer.

The group 83 of Web servers realizes the connection request receiver 33, the request processor 34, the tenant manager 35, the by-tenant applications 36, the tenant management application 37, the image processing system 38, and the cloud controller 39. At least one of the connection request receiver 33, the request processor 34, the tenant manager 35, the by-tenant applications 36, the tenant management application 37, the image processing system 38, and the cloud controller 39 may be realized by only one Web server or may be realized by a plurality of Web servers. At least one Web server in the group 83 may realize at least two of the connection request receiver 33, the request processor 34, the tenant manager 35, the by-tenant applications 36, the tenant management application 37, and the cloud controller 39. The image processing system 38 executes the save processing by a single Web server for each single save processing.

The image forming apparatus is configured by, for example, a Multifunction Peripheral (MFP), a printer-dedicated machine, or the like.

The user terminal is, for example, a computer configured by a Personal Computer (PC), a smartphone, or the like.

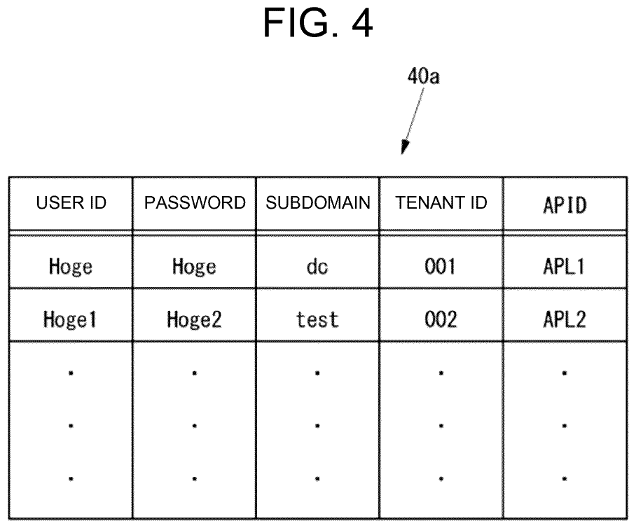

FIG. 4 is a diagram depicting an example of the tenant management table 40a.

The tenant management table 40a depicted in FIG. 4 stores a combination of: a user ID as identification information of a user; a password of a user; a subdomain of a tenant; a tenant ID as identification information of a tenant; and an APID as identification information of a by-tenant application. The tenant ID is, for example, a three digit numerical value excluding “000”.

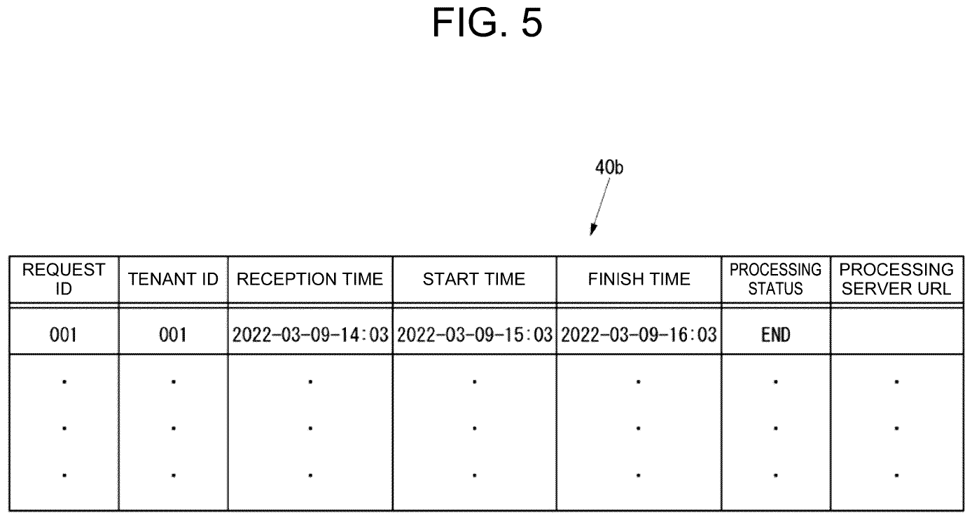

FIG. 5 is a diagram depicting an example of the save processing management table 40b.

The save processing management table 40b depicted in FIG. 5 stores, for respective save processing, a combination of: a request ID as identification information of a request for save processing from a user terminal application; a tenant ID of a tenant to which a user executing the save processing request belongs; a reception time of the save processing request from the user terminal application; a start time of the save processing; a finish time of the save processing; a processing status indicating a status of the save processing; and a processing server URL indicating a URL of a Web server executing the save processing among Web servers realizing the image processing system 38. The processing status involves “Ready” indicating that the execution of the save processing is waiting for, “Processing” indicating that the save processing is being executed, and “End” indicating that the execution of the save processing has finished. Although the value of the processing server URL is omitted in the save processing management table 40b depicted in FIG. 5, the URL of the Web server that executes the save processing is input actually.

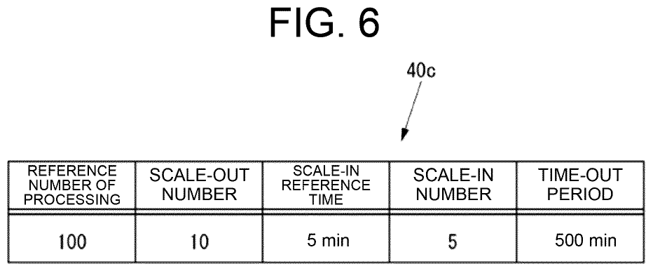

FIG. 6 is a diagram depicting an example of the setting table 40c.

The setting table 40c depicted in FIG. 6 involves: a reference number of processing set as the number of the save processing being executed, which is a reference for performing the scale-out and scale-in of the image processing system 38; a scale-out number set as the number of the scale-out for one time of the image processing system 38; a scale-in reference time set as a reference time of performing the scale-in of the image processing system 38; a scale-in number set as the number of the scale-in for one time of the image processing system 38; and a time-out period set as a time for time-out of the save processing.

Next, an operation of the system 20 will be described.

Hereinafter, the by-tenant application 36 and the user terminal application 70 will be described as examples of the by-tenant applications and the user terminal applications, respectively.

First, an operation of the system 20 when a session is established between the user terminal application 70 and the by-tenant application 36 will be described.

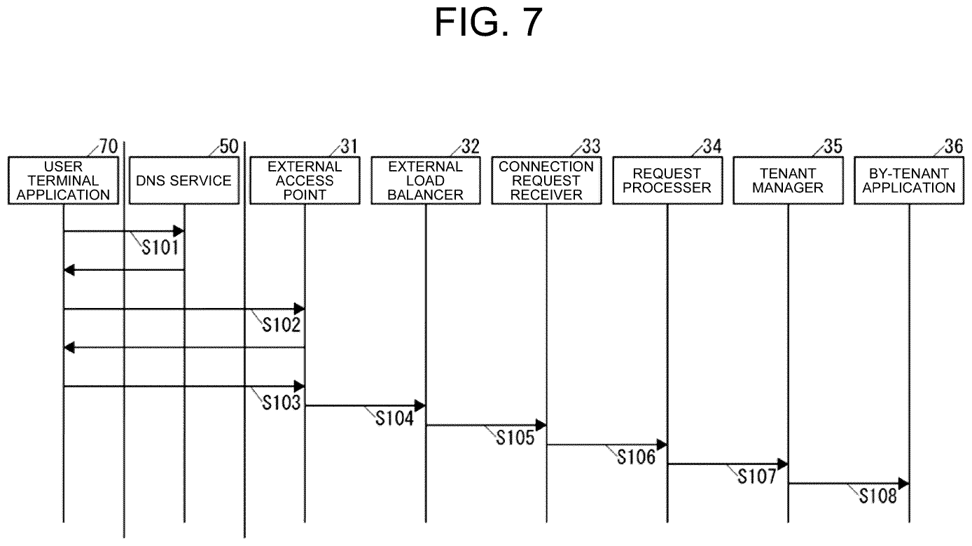

FIG. 7 is a sequence diagram depicting the operation of the system 20 when a session is established between the user terminal application 70 and the by-tenant application 36.

When a user wants to use the by-tenant application 36, the user can instruct, from the user terminal 88 to the user terminal application 70, the use of the by-tenant application 36.

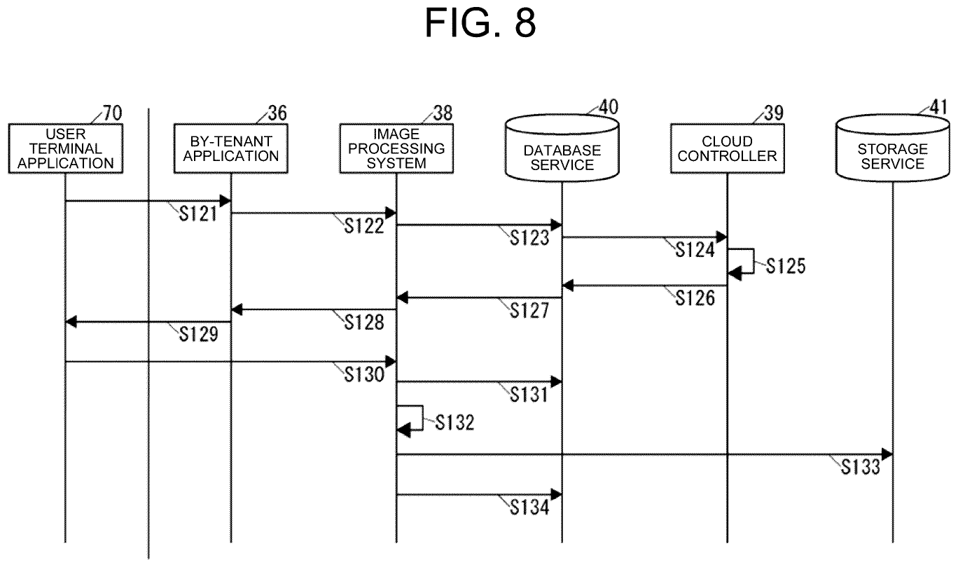

Hereinafter, it is assumed that the service name, i.e., the name of the solution 12 is “service.com”. It is assumed that the domain name of the external access point 31 is “cloud.app”. It is assumed that the subdomain of a tenant that realizes the by-tenant application 36 (hereinafter referred to as a “target tenant” in the description of the operation depicted in FIGS. 7 and 8) is “aap1”.

Upon instructed the use of the by-tenant application 36, the user terminal application 70 inquires of the DNS service 50 about the server name of the target tenant using FQDN, i.e., “aap1.service.com” (S101), as depicted in FIG. 7. In this connection, a wild card including the external access point 31, i.e., “*.cloud.app” is registered in the DNS service 50 as the server name. If the subdomain is, for example, “so-and-so”, the DNS service 50 returns a response “so-and-so.cloud.app” to a query including “so-and-so.service.com”. Therefore, the DNS service 50 responds “aap1.cloud.app” to the query including “aap1.service.com”.

Subsequent to the S101 processing, upon returned the server name of the target tenant from the DNS service 50, the user terminal application 70 connects with the external access point 31 using the server name returned from the DNS service 50, i.e., “aap1.cloud.app” (S102).

Subsequent to the S102 processing, upon connected with the external access point 31, the user terminal application 70 transmits an HTTP/HTTPS connection request to the external access point 31 (S103). The user terminal application 70 includes the user ID and password of the user and the subdomain of the target tenant in the HTTP/HTTPS connection request transmitted at S103.

Upon receiving the HTTP/HTTPS connection request transmitted at S103 from the user terminal application 70, the external access point 31 transfers the received HTTP/HTTPS connection request to the external load balancer 32 (S104).

Upon receiving the HTTP/HTTPS connection request transferred at S104 from the external access point 31, the external load balancer 32 establishes an HTTP/HTTPS connection with the user terminal application 70, and transfers the connection request received from the external access point 31 to the connection request receiver 33 (S105). In the case of HTTPS connection, the external load balancer 32 terminates Secure Sockets Layer (SSL).

Upon receiving the connection request transferred at S105 from the external load balancers 32, the connection request receiver 33 transfers the request received from the external load balancers 32 to the request processor 34 (S106).

Upon receiving the request transferred at S106 from the connection request receiver 33, the request processor 34 processes an authentication request with the user terminal application 70 based on the combination of the user ID and password included in the request received from the connection request receiver 33, acquires the subdomain included in the request received from the connection request receiver 33, and calls the tenant manager 35 (S107). In this connection, in the request received from the connection request receiver 33, the subdomain is indicated in, for example, HOST of HTTP REQUEST header.

Upon called at S107 by the request processor 34, the tenant manager 35 calls the by-tenant application 36 specified in the request from the user terminal application 70, among the by-tenant applications correlated with, in the tenant management table 40a, the subdomain acquired by the request processor 34 and the user ID of the user successfully authenticated in the request processor 34 (S108).

In the way described above, the session is established between the user terminal application 70 and the by-tenant application 36. Once the session is established between the user terminal application 70 and the by-tenant application 36, it becomes possible for the user terminal application 70 to transmit a request that uses REST API to the by-tenant application 36.

Next, an operation of the system 20 when at least one datum of the image data and the document data is transmitted from the user terminal application 70 to the image processing system 38 will be described.

FIG. 8 is a sequence diagram depicting the operation of the system 20 when at least one datum of the image data and the document data is transmitted from the user terminal application 70 to the image processing system 38.

When the session is established between the user terminal application 70 and the by-tenant application 36, a user can instruct, from the user terminal 88 to the user terminal application 70, save processing for at least one datum of the image data and the document data (hereinafter referred to as “transmission data” in the description of the operation depicted in FIG. 8).

Upon instructed the save processing for the transmission data, the user terminal application 70 requests the by-tenant application 36 to transmit the transmission data (S121), as depicted in FIG. 8.

Upon requested by the user terminal application 70 at S121 to transmit the transmission data, the by-tenant application 36 declares to the image processing system 38 the start of transmission of the transmission data (S122).

Upon declared by the by-tenant application 36 at S122 the start of transmission of the transmission data, the image processing system 38 generates a new record in the save processing management table 40b in the database service 40 (S123). In this connection, the image processing system 38 sets a request ID, a tenant ID, a reception time and a processing status, of the new record. For example, the image processing system 38 sets a request ID that has not yet been used in the save processing management table 40b as the request ID of the new record. Further, the image processing system 38 sets a tenant ID correlated with the target tenant in the tenant management table 40a as the tenant ID of the new record. Furthermore, the image processing system 38 sets a current time as the reception time of the new record. Yet further, the image processing system 38 sets “Ready” as the processing status of the new record.

Subsequent to the S123 processing, the database service 40 notifies the cloud controller 39 of the update of the save processing management table 40b (S124). In this connection, the database service 40 includes the request ID of the record generated at S123 in the notification at S124.

Upon notified by the database service 40 at S124 of the update of the save processing management table 40b, the cloud controller 39 executes a process of performing scale-out of the image processing system 38 as necessary (hereinafter referred to as “scale-out processing”) (S125).

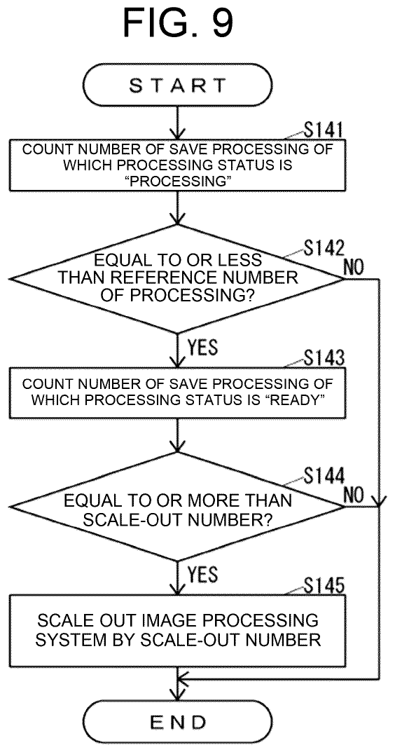

FIG. 9 is a flowchart of the operation of the cloud controller 39 when the scale-out processing is executed.

As depicted in FIG. 9, the cloud controller 39 counts the number of save processing of which the processing status is set “Processing” in the save processing management table 40b (S141).

Next, the cloud controller 39 determines whether or not the number counted at S141 is not more than the reference number of processing set in the setting table 40c (S142).

Upon determining at S142 that the number counted at S141 is not more than the reference number of processing set in the setting table 40c, the cloud controller 39 counts the number of save processing of which the processing status is set “Ready” in the save processing management table 40b (S143).

Next, the cloud controller 39 determines whether or not the number counted at S143 is not less than the scale-out number set in the setting table 40c (S144).

Upon determining at S144 that the number counted at S143 is not less than the scale-out number set in the setting table 40c, the cloud controller 39 scales out the image processing system 38 by the scale-out number set in the setting table 40c (S145). In other words, the cloud controller 39 increases the number of Web servers that realize the image processing system 38 by the scale-out number set in the setting table 40c.

The cloud controller 39 finishes the scale-out processing depicted in FIG. 9, upon determining at S142 that the number counted at S141 is more than the reference number of processing set in the setting table 40c, determining at S144 that the number counted at S143 is less than the scale-out number set in the setting table 40c, or finishing the S145 processing.

As depicted in FIG. 8, upon finishing the scale-out processing at S125, the cloud controller 39 sets URL of any one Web server that is not executing the save processing, among the Web servers that realize the image processing system 38, as a processing server URL in the record correlated with the request ID notified by the database service 40 at S124 in the save processing management table 40b (S126). In this connection, when the scale-out has been performed (S145) in the scale-out processing depicted in FIG. 9, the cloud controller 39 sets the URL of any one Web server newly ensured through the scale-out as the processing server URL.

Subsequent to the S126 processing, the database service 40 notifies the image processing system 38 of the processing server URL set at S126 and the request ID in the record of which the processing server URL is set at S126 (S127). Thus, it is possible for the image processing system 38 to execute the save processing by the Web server specified by the processing server URL notified at S127.

Upon notified by the database service 40 at S127 of the processing server URL and the request ID, the image processing system 38 notifies the by-tenant application 36 of the processing server URL and the request ID notified by the database service 40 at S127 (S128).

Upon notified by the image processing system 38 at S128 of the processing server URL and the request ID, the by-tenant application 36 notifies the user terminal application 70 of the processing server URL and the request ID notified by the image processing system 38 at S128 (S129).

Upon notified by the by-tenant application 36 at S129 of the processing server URL and the request ID, the user terminal application 70 transmits the transmission data to the Web server specified by the processing server URL notified by the by-tenant application 36 at S129, among the Web servers that realize the image processing system 38 (S130). In this connection, the user terminal application 70 includes the request ID notified by the by-tenant application 36 at S129 in the transmission at S130 .

Upon transmitted the transmission data from the user terminal application 70 at S130, the image processing system 38 sets a current time as a start time in the record that is specified in the save processing management table 40b by the request ID transmitted together with the transmission data from the user terminal application 70, and changes a processing status in the record to “Processing” (S131). In other words, the image processing system 38 records the start of execution of the save processing in the save processing management table 40b.

Subsequent to the S131 processing, the image processing system 38 performs, as needed, a specific conversion process on the transmission data transmitted from the user terminal application 70 at S130 (S132). The conversion process performed at S132 involves, for example, a process of converting the image format of the transmission data in a case where the transmission data is image data. The process of converting the image format of the transmission data involves, for example, a process of converting the transmission data into Portable Document Format (PDF) data with a full-text search function, in a case where the transmission data is Joint Photographic Experts Group (JPEG) data. The conversion process performed at S132 also involves, for example, Optical Character Recognition (OCR) that extracts character information from the transmission data in a case where the transmission data is image data. Further, the conversion process performed at S132 involves, for example, indexing that extracts a keyword from the transmission data in a case where the transmission data is PDF data or the like. The conversion process performed at S132 is designated by the user through the user terminal application 70. Note that the conversion process at S132 may be omitted.

Subsequent to the S132 processing, the image processing system 38 saves, in the storage service 41, the transmission data transmitted from the user terminal application 70 at S130 if the conversion process is not performed at S132, while the transmission data that have been subjected to the conversion process performed at S132 if the conversion process is performed at S132 (S133). In a case where the process such that a keyword is extracted from the transmission data is performed at S132, the image processing system 38 may save the information such as the keyword generated at S132 in the database service 40 at S133. The information saved in the database service 40 at S133 is used, for example, to search for at least one datum of the image data and the document data saved in the storage service 41.

Subsequent to the S133 processing, the image processing system 38 sets a current time as a finish time in the record that is specified in the save processing management table 40b by the request ID transmitted together with the transmission data from the user terminal application 70 at S130, and changes a processing status in the record to “End” (S134). In other words, the image processing system 38 records the finish of execution of the save processing in the save processing management table 40b.

The above description is directed to a case where at least one datum of the image data and the document data is transmitted from the user terminal application to the image processing system 38. However, the description may be analogously directed to a case where at least one datum of the image data and the document data is transmitted from the image forming apparatus program to the image processing system 38.

Next, the operation of the cloud controller 39 when the cloud controller 39 executes a process of performing scale-in as necessary (hereinafter referred to as “scale-in processing”) will be described.

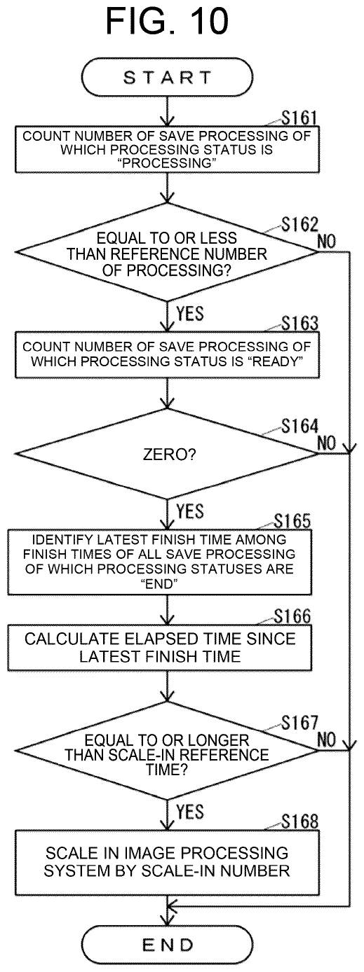

FIG. 10 is a flowchart of the operation of the cloud controller 39 when the scale-in processing is executed.

The cloud controller 39 executes the process depicted in FIG. 10 at periodic timing, for example, every five minutes, etc.

As depicted in FIG. 10, the cloud controller 39 counts the number of save processing of which the processing status is set “Processing” in the save processing management table 40b (S161).

Next, the cloud controller 39 determines whether or not the number counted at S161 is not more than the reference number of processing set in the setting table 40c (S162).

Upon determining at S162 that the number counted at S161 is not more than the reference number of processing set in the setting table 40c, the cloud controller 39 counts the number of save processing of which the processing status is set “Ready” in the save processing management table 40b (S163).

Next, the cloud controller 39 determines whether or not the number counted at S163 is zero (S164).

Upon determining at S164 that the number counted at S163 is zero, the cloud controller 39 identifies the latest finish time among finish times of all save processing of which the processing statuses are set “End” in the save processing management table 40b (S165).

Next, the cloud controller 39 calculates an elapsed time since the latest finish time identified at S165 by subtracting the latest finish time identified at S165 from a current time (S166).

Next, the cloud controller 39 determines whether or not the elapsed time calculated at S166 is not shorter than the scale-in reference time set in the setting table 40c (S167).

Upon determining at S167 that the elapsed time calculated at S166 is not shorter than the scale-in reference time set in the setting table 40c, the cloud controller 39 scales in the image processing system 38 by the scale-in number set in the setting table 40c (S168). In other words, the cloud controller 39 decreases the number of Web servers that realize the image processing system 38 by the scale-in number set in the setting table 40c.

The cloud controller 39 finishes the operation depicted in FIG. 10, upon determining at S162 that the number counted at S161 is more than the reference number of processing set in the setting table 40c, determining at S164 that the number counted at S163 is not zero, determining at S167 that the elapsed time calculated at S166 is shorter than the scale-in reference time set in the setting table 40c, or finishing the S168 processing.

Next, the operation of the cloud controller 39 when the cloud controller 39 executes a process of stopping the Web server in accordance with an elapsed time since a start time of save processing being executed (hereinafter referred to as “time-out processing”) will be described.

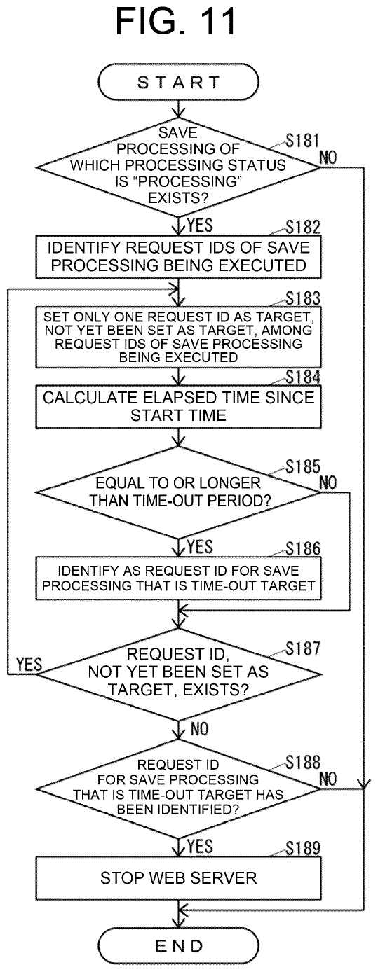

FIG. 11 is a flowchart of the operation of the cloud controller 39 when the time-out processing is executed.

The cloud controller 39 executes the process depicted in FIG. 11 at periodic timing, for example, every five minutes, etc.

As depicted in FIG. 11, the cloud controller 39 determines whether or not save processing of which the processing status is set “Processing” in the save processing management table 40b exists (S181).

Upon determining at S181 that save processing of which the processing status is set “Processing” in the save processing management table 40b exists, the cloud controller 39 identifies request IDs of all save processing of which the processing statuses are set “Processing” in the save processing management table 40b as the request IDs of the save processing being executed (S182).

Next, the cloud controller 39 sets, among the request IDs of the save processing being executed identified at S182, only one request ID as a target of processing (S183), which has not yet been set as a target of processing at S183 in the this-time operation depicted in FIG. 11.

Next, the cloud controller 39 calculates an elapsed time since a start time set in the save processing management table 40b in relation to the save processing identified by the request ID that is the current target of processing, by subtracting the start time set in the save processing management table 40b in relation to the save processing identified by the request ID that is the current target of processing from a current time (S184).

Next, the cloud controller 39 determines whether or not the elapsed time calculated at S184 is not shorter than a time-out period set in the setting table 40c (S185).

Upon determining at S185 that the elapsed time calculated at S184 is not shorter than the time-out period set in the setting table 40c, the cloud controller 39 identifies the request ID that is the current target of processing as a request ID for the save processing that is a target of time-out (S186).

Upon determining at S185 that the elapsed time calculated at S184 is shorter than the time-out period set in the setting table 40c or finishing the S186 processing, the cloud controller 39 determines whether or not a request ID that has not yet been set as a target of processing at S183 in the this-time operation depicted in FIG. 11 exists, among the request IDs of the save processing being executed identified at S182 (S187).

Upon determining at S187 that a request ID that has not yet been set as a target of processing at S183 in the this-time operation depicted in FIG. 11 exists, among the request IDs of the save processing being executed identified at S182, the cloud controller 39 executes the S183 processing.

Upon determining at S187 that a request ID that has not yet been set as a target of processing at S183 in the this-time operation depicted in FIG. 11 does not exist, among the request IDs of the save processing being executed identified at S182, the cloud controller 39 determines whether or not a request ID for the save processing that is a target of time-out has been identified at S186 in the this-time operation depicted in FIG. 11 (S188).

Upon determining at S188 that a request ID for the save processing that is a target of time-out has been identified at S186 in the this-time operation depicted in FIG. 11, the cloud controller 39 stops all Web servers identified by processing server URLs correlated with, in the save processing management table 40b, the request ID for the save processing that is the target of time-out identified at S186 in the this-time operation depicted in FIG. 11 (S189).

The cloud controller 39 finishes the operation depicted in FIG. 11, upon determining at S181 that save processing of which the processing status is set “Processing” in the save processing management table 40b does not exist, determining at S188 that a request ID for the save processing that is a target of time-out has not been identified at S186 in the this-time operation depicted in FIG. 11, or finishing the S189 processing.

In the time-out processing depicted in FIG. 11, the cloud controller 39 stops the Web server in which the elapsed time since the start time of execution of the save processing is not shorter than the time-out period (S189). However, in the time-out processing, the cloud controller 39 may recover from an error of the Web server in which the elapsed time since the start time of execution of the save processing is not shorter than the time-out period, instead of stopping the Web server in which the elapsed time since the start time of execution of the save processing is not shorter than the time-out period. In this connection, a method of recovering from the error of the Web server involves, for example, a method of restarting the Web server.

In the tenant management system 30, when at least one of the tenant and the by-tenant application is increased, the number of occurrences of the save processing is likely to be increased. In addition, in the tenant management system 30, at least one datum of the image data and the document data is subjected to the save processing, so that the size of data to be subjected to the save processing is large and, consequently, the time required for the save processing is long. Furthermore, in the tenant management system 30, the case where the save processing includes the conversion process increases the time required for the save processing. Thus, the tenant management system 30 performs as necessary the scale-out of the image processing system 38 that executes the save processing, in order to reduce the possibility of deteriorating usability. On the other hand, the tenant management system 30 performs as necessary the scale-in of the image processing system 38, in order to reduce the possibility of increasing in cost in the public cloud 11 that is charged based on the amount of use of resources.

The tenant management system 30 executes the scale-out processing (S125) before execution of the save processing by the image processing system 38 for respective save processing (S131 to S134), so that it is possible to reduce the possibility of performing too much or too little the scale-out of the image processing system 38. Therefore, the tenant management system 30 is capable of effectively performing the scale-out.

The tenant management system 30 does not perform the scale-out (S145) of the image processing system 38 when the number of the save processing being executed is more than the reference number of processing (“NO” at S142), so that it is possible to prevent the scale-out of the image processing system 38 from being performed endlessly. Therefore, the tenant management system 30 is capable of effectively performing the scale-out.

The tenant management system 30 does not perform the scale-out (S145) of the image processing system 38 when the number of the save processing waiting for execution is less than the scale-out number (“NO” at S144), so that it is possible to prevent the scale-out of the image processing system 38 from being performed in spite of a light load that is predicted by a future execution of the save processing by the image processing system 38. Therefore, the tenant management system 30 is capable of effectively performing the scale-out.

The tenant management system 30 performs the scale-out of the image processing system 38 by the scale-out number (S145) when the number of the save processing being executed is not more than the reference number of processing (“YES” at S142) and the number of the save processing waiting for execution is not less than the scale-out number (“YES” at S144), so that it is possible to scale out the image processing system 38 by necessary amount of the scale-out of the image processing system 38 when the scale-out of the image processing system 38 is required. Therefore, the tenant management system 30 is capable of effectively performing the scale-out.

The cloud controller 39 may perform the scale-out of the image processing system 38 by another method, instead of the above-described method or in addition to the above-described method. For example, the cloud controller 39 may perform the scale-out of the image processing system 38 at a timing other than the “timing before execution of the save processing by the image processing system 38 for respective save processing”.

The tenant management system 30 executes the scale-in processing of the image processing system 38 periodically (S161 to S168), so that it is possible to perform the scale-in of the image processing system 38 at an appropriate timing. Therefore, the tenant management system 30 is capable of effectively performing the scale-in.

The tenant management system 30 does not perform the scale-in (S168) of the image processing system 38 when the number of the save processing being executed is more than the reference number of processing (“NO” at S162), so that it is possible to reduce the possibility of performing the scale-in of the image processing system 38 in spite of the large number of the save processing being executed, and thus of hindering the execution of the save processing. Therefore, the tenant management system 30 is capable of effectively performing the scale-in.

The tenant management system 30 does not perform the scale-in (S168) of the image processing system 38 when the save processing waiting for execution exists (“NO” at S164), so that it is possible to reduce the possibility of performing the scale-in of the image processing system 38 in spite of existence of the save processing waiting for execution, and thus of hindering the future execution of the save processing. Therefore, the tenant management system 30 is capable of effectively performing the scale-in.

The tenant management system 30 does not perform the scale-in (S168) of the image processing system 38 when the elapsed time since the finish time of the save processing of which execution is finished last is shorter than the scale-in reference time (“NO” at S167), so that it is possible to reduce the possibility of performing the scale-in of the image processing system 38 immediately after finishing the save processing, and thus of hindering the future execution of the save processing. Therefore, the tenant management system 30 is capable of effectively performing the scale-in.

The tenant management system 30 performs the scale-in of the image processing system 38 by the scale-in number (S168) when the number of the save processing being executed is not more than the reference number of processing and the save processing waiting for execution does not exist (“YES” at S162 and “YES” at S164) as well as the elapsed time since the finish time of the save processing of which execution is finished last is not shorter than the scale-in reference time (“YES” at S167), so that it is possible to scale in the image processing system 38 by necessary amount of the scale-in of the image processing system 38 when the scale-in of the image processing system 38 is required. Therefore, the tenant management system 30 is capable of effectively performing the scale-in.

The cloud controller 39 may perform the scale-in of the image processing system 38 by another method, instead of the above-described method or in addition to the above-described method. For example, the cloud controller 39 may perform the scale-in of the image processing system 38 at a timing other than the periodic timing.

In the tenant management system 30, for example, when the size of at least one datum of the image data and the document data, which is to be subjected to the save processing, is too large, or when the conversion process in the save processing has a bug, the save processing may probably be backlogged for a long time. Further in the tenant management system 30, the number of occurrences of the save processing is likely to be increased due to increase in at least one of the tenant and the by-tenant application, and thus the probability of long-time backlogging of the save processing increases when at least one of the tenant and the by-tenant application increases.

The tenant management system 30 stops the Web server (S189) or recovers from the error of the Web server when the elapsed time since the start time of the save processing being executed by the Web server is not shorter than the time-out period (“YES” at S185), so that when the processing is backlogged for a long time in the Web server that realizes the image processing system 38, it is possible to reduce the possibility of continuously using the said Web server as it is. Therefore, the tenant management system 30 is capable of efficiently using the Web server that realizes the image processing system 38.

The tenant management system 30 executes the time-out processing of the image processing system 38 periodically (S181 to S189), so that it is possible to execute the time-out processing of the image processing system 38 at an appropriate timing.

Therefore, the tenant management system 30 is capable of efficiently using the Web server that realizes the image processing system 38.

### DESCRIPTION OF REFERENCE NUMERALS

30 . . . TENANT MANAGEMENT SYSTEM (CLOUD SYSTEM)
38 . . . IMAGE PROCESSING SYSTEM (DATA SAVING SYSTEM)
39 . . . CLOUD CONTROLLER
40 . . . DATABASE SERVICE (SPECIFIC LOCATION)
41 . . . STORAGE SERVICE (SPECIFIC LOCATION)
83 . . . GROUP OF WEB SERVERS (SERVERS)

1. (canceled)

2. A cloud system comprising:
a data saving system that executes save processing which is a process of saving data received from outside in a specific location; and
a cloud controller that executes scale-out processing which is a process of performing scale-out of the data saving system as necessary,
wherein the cloud controller executes the scale-out processing before execution of the save processing by the data saving system for respective save processing, and the scale-out processing is a process in which the cloud controller does not perform the scale-out when a number of the save processing being executed is more than a reference number of processing set as a reference for performing the scale-out.

3.The cloud system of claim 2, wherein the scale-out processing is a process in which the cloud controller does not perform the scale-out when a number of the save processing waiting for execution is less than a scale-out number set as a number of the scale-out for one time.

4. The cloud system of claim 3, wherein the scale-out processing is a process in which the cloud controller performs the scale-out by the scale-out number when the number of the save processing being executed is not more than the reference number of processing and the number of the save processing waiting for execution is not less than the scale-out number.

5. The cloud system of claim 2, wherein the scale-out processing is a process in which the cloud controller does not perform the scale-out when a number of the save processing waiting for execution is less than a scale-out number set as a number of the scale-out for one time.

6. The cloud system of claim 2, wherein the scale-out processing is a process in which the cloud controller performs the scale-out by a scale-out number when a number of the save processing being executed is not more than a reference number of processing set as a reference for performing the scale-out and a number of the save processing waiting for execution is not less than the scale-out number set as a number of the scale-out for one time.

7. (canceled)

8. A cloud system comprising:
a data saving system that executes save processing which is a process of saving data received from outside in a specific location; and
a cloud controller that executes scale-in processing which is a process of performing scale-in of the data saving system as necessary,
wherein the cloud controller executes the scale-in processing periodically, and the scale-in processing is a process in which the cloud controller does not perform the scale-in when a number of the save processing being executed is more than a reference number of processing set as a reference for performing the scale-in.

9. The cloud system of claim 8, wherein the scale-in processing is a process in which the cloud controller does not perform the scale-in when the save processing waiting for execution exists.

10. The cloud system of claim 9, wherein the scale-in processing is a process in which the cloud controller does not perform the scale-in when an elapsed time since a finish time of the save processing of which execution is finished last is shorter than a scale-in reference time set as a reference time of performing the scale-in.

11. The cloud system of claim 10, wherein the scale-in processing is a process in which the cloud controller performs the scale-in by a scale-in number set as a number of the scale-in for one time when the number of the save processing being executed is not more than the reference number of processing, the save processing waiting for execution does not exist, and the elapsed time since the finish time of the save processing of which execution is finished last is not shorter than the scale-in reference time.

12. (canceled)

13. (canceled)

14. The cloud system of claim 8, wherein the scale-in processing is a process in which the cloud controller performs the scale-in by a scale-in number set as a number of the scale-in for one time when a number of the save processing being executed is not more than a reference number of processing set as a reference for performing the scale-in, the save processing waiting for execution does not exist, and an elapsed time since a finish time of the save processing of which execution is finished last is not shorter than a scale-in reference time set as a reference time of performing the scale-in.

15. (canceled)

16. (canceled)
